(19) United States
(12) Patent Application Publication
(10) Pub. No.: US 2013/0207901 A1
(43) Pub. Date: Aug. 15, 2013

(54) Virtual Created Input Object

(71) Applicants: Lioudmila Lucy BLANTS, Espoo (FI); Juha Heikki ALAKARHU, Helsinki (FI); Janne Joonas ITARANTA, Helsinki (FI); John SAMUELS, Lancashire (GB)

(72) Inventors: Lioudmila Lucy BLANTS, Espoo (FI); Juha Heikki ALAKARHU, Helsinki (FI); Janne Joonas ITARANTA, Helsinki (FI); John SAMUELS, Lancashire (GB)

(73) Assignee: Nokia Corporation

(21) Appl. No.: 13/370,605

(22) Filed: Feb. 10, 2012

(51) Int. Cl. G06F 3/041

(52) U.S. Cl. 345/173

(57) ABSTRACT

An apparatus including an electrical touch surface; and a controller connected to the touch surface. Based upon a user drawing a symbol on the touch surface, the controller is configured to create a virtual user input object at the touch surface corresponding to the drawn symbol.

### BACKGROUND

1. Technical Field

The exemplary and non-limiting embodiments relate generally to an input device and, more particularly, to a virtual input object.

2. Brief Description of Prior Developments

Touch screens are known which allow a user to interact with an apparatus. For example, a user can use finger movements on a touch screen to move an image of a picture around on the touch screen, or use fingers to enlarge or reduce a view of the image. Applications also use icons to allow a user to interact with the application by finger movements on the touch screen relative to the icons.

### SUMMARY

The following summary is merely intended to be exemplary. The summary is not intended to limit the scope of the claims.

In accordance with one aspect, an apparatus is provided comprising an electrical touch surface; and a controller connected to the touch surface. Based upon a user drawing a symbol on the touch surface, the controller is configured to create a virtual user input object at the touch surface corresponding to the drawn symbol.

In accordance with another aspect, a method comprises drawing a symbol by a user with an electronic input device; and creating a virtual user input object for use by the user with the electronic input device corresponding to the drawn symbol.

In accordance with another aspect, a non-transitory program storage device is provided readable by a machine, tangibly embodying a program of instructions executable by the machine for performing operations, the operations comprising based upon a user drawing a symbol with an electronic input device, creating a virtual input object for use by the user with the electronic input device corresponding to the drawn symbol; and using user interaction with the virtual input object to perform at least one function.

### BRIEF DESCRIPTION OF THE DRAWINGS

The foregoing aspects and other features are explained in the following description, taken in connection with the accompanying drawings, wherein:

FIG. 1 is a perspective view of an example embodiment;

FIG. 2 is a diagram illustrating some of the components of the embodiment shown in FIG. 1;

FIG. 3 is an illustration of a symbol drawn on the touch screen shown in FIGS. 1-2;

FIG. 4 is an illustration of a virtual user input object on the touch screen shown in FIGS. 1-2;

FIG. 5 is an illustration of the correspondence between the symbol shown in FIG. 3 and the resultantly created object shown in FIG. 4;

FIG. 6 is an illustration of how the symbol and/or object can be created at a different location or moved to a different location;

FIG. 7 is an illustration of how the symbol and/or object can be created larger or made larger after creation;

FIGS. 8A and 8B illustrate a different example of a possible symbol/object;

FIGS. 9A and 9B illustrate another different example of a possible symbol/object; and

FIG. 10 is a diagram illustrating some steps of one example method.

### DETAILED DESCRIPTION OF EMBODIMENTS

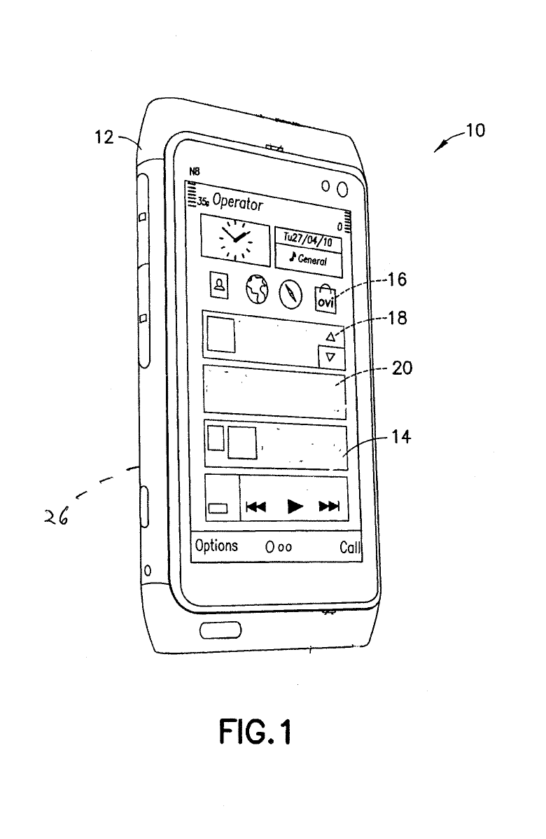

Referring to FIG. 1, there is shown a perspective view of an apparatus 10 incorporating features of an example embodiment. Although the features will be described with reference to the example embodiments shown in the drawings, it should be understood that features can be embodied in many alternate forms of embodiments. In addition, any suitable size, shape or type of elements or materials could be used.

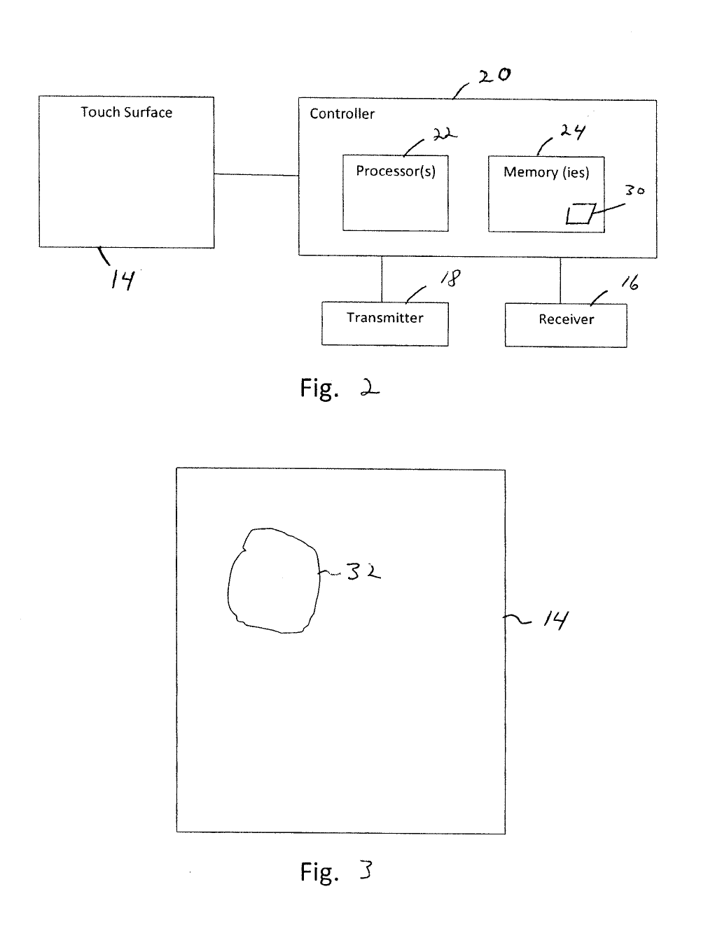

The apparatus 10 in this example is a hand-held portable electronic device comprising a telephone application, Internet browser application, camera application, video recorder application, music player and recorder application, email application, navigation application, gaming application, and/or any other suitable electronic device application. The apparatus 10, in this example embodiment, comprises a housing 12, a touch screen 14 which functions as both a display and a user input, a receiver 16, a transmitter 18, a controller 20 which can include (referring also to FIG. 2) at least one processor 22, at least one memory 24, software 30, and a rechargeable battery 26. However, all of these features are not necessary to implement the protection described below. For example, features could be used in any suitable type of electronic device having a touch surface as a user input, such as a computer touch pad, or a touch screen on any type, of apparatus including, for example, a cash register, a music player or mixer, a digital video recorder.

As seen in FIG. 2, the touch screen 14 forms a touch surface for a user to use as an input device for interacting with applications on the apparatus 10. In an alternate example embodiment the touch surface might not be a touch screen, such as a computer touch pad for example. The apparatus 10 comprises a controller 20 which includes the processor(s) 22, the memory(ies) 24 and computer software/programming 30 such as applications for example.

The apparatus 10 is configured to allow a user to create a virtual user input object on the touch surface 14. The apparatus 10 could be configured to allow the user and apparatus to create multiple different virtual user input objects, such as based upon the application being used by the user for example. In order create the virtual user input object, the user first draws a symbol on the touch surface 14. After the user draws the symbol, the apparatus 10 can then create a virtual user input object at the touch surface 14 for the user to subsequently use to interact with an application.

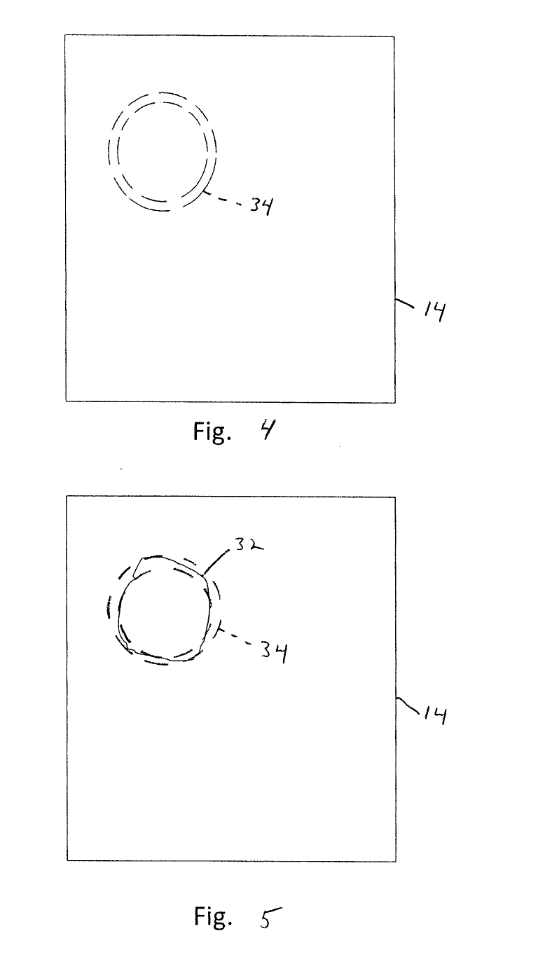

Referring also to FIG. 3, the touch screen 14 is shown where a user has used his finger to draw a symbol 32 representative of a circle. Referring also to FIG. 4, based upon the symbol 32 drawn by the user, the controller 20 is configured create a virtual user input object 34 for use by the user at the touch screen 14. Referring also to FIG. 5, in this example the symbol 32 drawn by the user remains visible on the touch screen 14, and the object 34 is superimposed at a same location, but not necessarily seen by the user. In an alternate example embodiment the symbol 32 could disappear and be replaced by a visible symbol equal to the object 34. In another example, the symbol 32 could remain visible and another symbol representative of the object could be visible. In another alternate example embodiment the symbol 32 might never be visible, or could disappear shortly after being drawn; with or without a symbol representative of the object 34 being made visible.

Once the virtual user input object 34 has been created, the user can now use that object 34 to interact with an application being used by the apparatus 10. For example, the application might be a camera application for taking pictures or a picture viewing application for viewing pictures. With the apparatus 10 using the camera application, the camera application could automatically designate the object 34 as a zoom control to allow the user to indicate to the camera application the area in the symbol/object 32/34 for determining focal length of the camera lens. Alternatively or additionally, the user could move his/her finger clockwise around the symbol/object 32/34 to zoom IN on the area inside the symbol/object 32/34, and move his/her finger counter-clockwise around the symbol/object 32/34 to zoom OUT on the area inside the symbol/object 32/34, such as before a picture is taken for example.

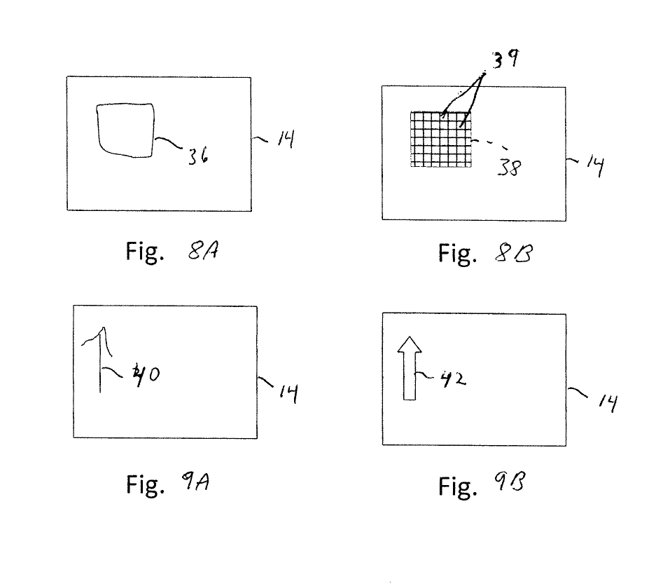

The input object 34 could be created at any suitable location on the display screen 14; such as dependent upon where the user draws the symbol 32. Likewise, in this example the size and/or shape of the symbol 32 is, at least initially, controlled by the user; not by the apparatus 10. The apparatus 10 merely creates the subsequent object 34 based upon the size, shape and location of the user drawn symbol 32. For example, Fig. shows the same symbol 32 having been drawn at a different location on the display 14 and the resultant object 34 being created with the symbol. As another example, FIG. 7 shows the same symbol 32 having been drawn at a different location and much larger on the display 14 and the resultant larger object 34 being created with the symbol.

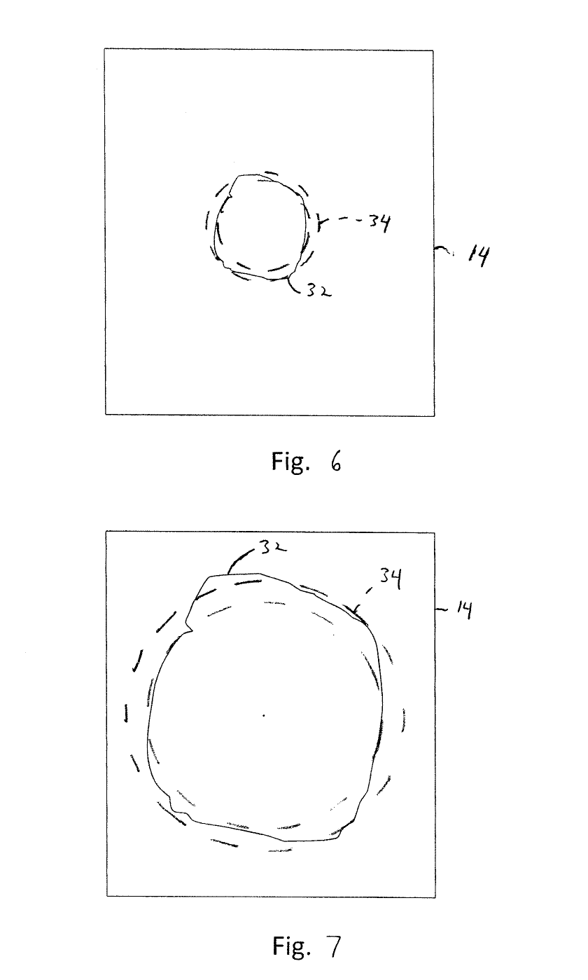

The apparatus could also be configured to allow the symbol/object 32/34 to be moved on the display after they are drawn/created. For example, if the symbol/object 32/34 is first located at the position shown in FIG. 3, the apparatus could be configured to allow the user to move the symbol/object 32/34 to a new location as shown in FIG. 6. As another example, if the symbol/object 32/34 are first formed with the size shown in FIG. 3, the apparatus 10 can be configured to allow the user to enlarge the symbol/object 32/34 to a larger size as shown in FIG. 7 or reduce the size to a smaller size.

The apparatus 10 can be programmed to recognize different symbols drawn by the user and create a virtual user input object based upon that recognized drawn symbol. For example, referring to FIGS. 8A and 8B, if the user draws the symbol 36 representative of a square, the apparatus 10 might recognize the drawn symbol 36 and create a grid object 38 for the user to subsequently select one of the grid sub-sections 39 for enlargement. Object 38 may not be visible on the touch screen 14. Only symbol 36 might be visible, but the object 38 would still be present for use. As another example, referring also to FIGS. 9A and 9B, if the user draws the symbol 40 representative of an arrow, the apparatus 10 might be programmed to recognize the drawn symbol 40 and create an arrow object 42. Again, the object 42 might not be visible, but its functionality would be present (regardless of whether symbol 40 is shown or continues to be shown).

The created user input object at least partially corresponds to the symbol drawn by the user. Stated another way, the user draws a symbol at least partially symbolic of the type of virtual user input object the user wants to use. The apparatus can then recognize the symbol drawn by the user and create the corresponding object which the user has requested by drawing the symbol. In one type of alternate example, the user input object could be created to be virtually identical to the symbol drawn by the user.

The virtual user input object created may be determined based upon the application being run by the apparatus at the time the symbol is drawn. For example, if a picture viewer application is in use by the apparatus 10 when the user draws the circle symbol 32, the resultant object 34 may be a picture zoom virtual input object to allow the user to zoom IN an OUT by making the symbol/object 32/34 smaller and larger. However, if a music player application is in use by the apparatus 10 when the user draws the circle symbol 32, the resultant object 34 could be a volume control virtual input object to allow the user to increase and decrease volume by moving the user's finger clockwise and counter-clockwise around the symbol/object 32/34.

It should be noted that drawing of the symbol 32 is not limited to only a user's finger on the touch surface 14. A stylus could be used. In another example, a voice command could be used to draw the symbol 32; perhaps in conjunction with the user touching the touch screen. For example, the user could touch the touch screen and say “circle”. The apparatus could then draw a circle at the location of the user's touch, and the apparatus could subsequently create the virtual user input object 34.

With features described above, a user can create his/her own arrangement or configuration of user input object(s) on the display screen based upon his/her needs, likes and dislikes. For example, a person with visual sight disabilities or large fingers, could make the symbol/object 32/34 large. As another example, a person viewing a movie on the apparatus 10 could draw a pause symbol “ [symbol] ” on the touch screen 14 and activate an equivalent resultant virtual user input “pause” object to pause the movie without having to bring up a menu screen. Because the user does not need to bring up a menu, control of the apparatus is much more simplified, and menus can be designed to pop-up less often; thereby enhancing viewing of content without accidental menu pop-ups.

Certain symbols are very well known, such as the pause symbol for example, and apply to multiple different applications, such as a music player application, a picture viewer, a movie/television viewer, etc. Once understood how to be used by the general public, user initiated semi-custom created virtual input objects (34, 38, 42 for example) can become intuitive across multiple applications without the user having to be instructed for each application.

The general concept described above relates to a virtual input device or object. In the past, for example, if the user is using a mobile device as a camera, then in order to activate features/functions the user must either scroll through a menu or have a dedicated input device e.g. for zoom. Features described above outline a virtual input device that may be created on a surface of a touch device as and when a user needs it. For example, a user can “draw” a virtual symbol on the touch screen (or other touch surface) representing a ring of lens of a SLR camera. The user can freely choose the size and position on the screen. When the ring is created, it can appear as visible, if chosen so. If chosen to be invisible or hidden, it does not obstruct the view on the screen. The apparatus can automatically create an equivalent or corresponding ring input object. In one type of example embodiment, after the ring object is created, the user can feel the ring as a physical ring through electromagnetic tactile feedback provided by the touch screen 14. In the same manner other virtual objects representing SLR camera elements can be created and used.

In the above example, the user can create the ring by first using his/her finger and mimicking a circle on the touch sensitive surface. Once the shape of the ring has been completed, the circle is displayed. Alternatively, or additionally, the area outlined is enabled for electrotactility so on subsequent circular movements over the same defined area, the user will feel a virtual input device. In addition and/or as an alternative, the virtual user input object could be created by an audio signal, such as a speech command. For example, the user could say “control circle upper right”, and the apparatus could create the circle in the upper right quadrant of the touch screen. In addition and/or as an alternative, the output could be audio output in addition to electrotactile output or as an alternative to electrotactile output. This could help with users who have visual disabilities and all users operating the device in difficult conditions such as low light.

The virtual circular input object can be used to zoom, for example, dependent upon the direction of rotation. The device can create the virtual input object dependent upon the application. Thus, as a user is focusing on a subject on the touch screen, the apparatus will know that a circular motion corresponds to zoom. As well as creating the virtual user input object, it will also know it is associated with a zooming action. The virtual input object can disappear once the image has been taken or once the application has closed.

Additionally, as an alternative embodiment, once the virtual ring is created the end user may then be able to have a 3D aspect. For example, once the virtual ring is defined the device may know that the virtual input object should be operable to detect “hover” (i.e. that is when the user has his/her finger above the touch element but not directly touching it). If “hover” is allowed by the device then the user can also use the Z-axis (away from and towards the device) to create additional controls. For example, movement in the Z-axis may correspond to auto focus or zooming. “Hover” can be detected using, for example, sensitive proximity sensors or sensitive capacitive sensors embedded in the touch screen surface.

Features described above can provide the advantage that the user can create a virtual input object dependent upon the application. Thus, a virtual input device can be at least partially designed and created by the user. The virtual input object may be dependent upon the application in use when it is created. The virtual input object operation may be dependent upon the application in use when it is created. The virtual input object may have a visual and/or electrotactility sense. The virtual input object may be automatically removed upon the application ending or an image being taken. The virtual input object may have a 3D aspect (i.e. hover detection is localized where the virtual input object is created). Virtual objects for complex image capture commands on touch screens using haptics technology may be provided.

Features of an example embodiment may be provided in an apparatus 10 comprising an electrical touch surface 14; and a controller 20 connected to the touch surface, where based upon a user drawing a symbol 32 on the touch surface the controller is configured to create a virtual user input object 34 at the touch surface corresponding to the drawn symbol.

The controller may be configured to create the virtual user input object 34 based upon an application in use by the apparatus when the symbol is drawn. The controller may be configured to use input by the user with the virtual user input object 34 a first way with a first application, and to use the input by the user with the virtual user input object 34 a second different way with a second different application. For example, if input object is a ring shaped object, the same ring shaped object could be used a first way (focus) for a camera application or used a second way (volume control) for a music player application. In this example, the input by the user could be circular motions with the same object for the two different applications. The controller may be configured to make the symbol 32 drawn by the user visible on the touch surface as the symbol is being drawn. The controller may be configured to make the symbol 32 drawn by the user reduce in visibility after being drawn, but while the object 34 is still available for use. The controller may be configured to provide electrotactility sensation on the touch surface corresponding to the virtual user input object. The controller may be configured to discontinue the virtual user input object 34 based upon ending of an application or taking a picture or stopping a recording. The touch surface and the controller may be configured to use movement of a user's finger towards and away from the touch surface at the drawn symbol 32 as an input component to the virtual user input object 34. The controller may be configured to allow the user to move the drawn symbol 32 on the touch surface and move the virtual user input object 34 with the drawn symbol. The controller may be configured to allow the user to change a size of the drawn symbol 32 on the touch surface and change a size of the virtual user input object 34 with the drawn symbol. The electrical touch surface may be a touch screen. The apparatus 10 may comprise means for allowing a user to initiate of a semi-custom user input object on the touch screen as the virtual user input object.

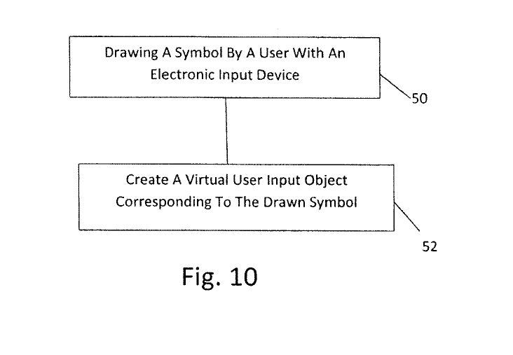

Referring also to FIG. 10, an example method may comprise drawing a symbol 32 by a user with an electronic input device 14 as indicated by block 50; and creating a virtual user input object 34 for use by the user with the electronic input device corresponding to the drawn symbol as indicated by block 52.

Drawing a symbol by a user “with” an electronic input device can include use of an input device other than a touch screen (such as a device which senses the user's hand in 3-D space for example. The virtual user input object 34 may be created based, at least partially, upon an application in use by an apparatus having the electronic input device when the symbol is drawn. The method may further comprise using input by the user with the virtual user input object 34 a first way with a first application, and using the input by the user with the virtual user input object 34 a second different way with a second different application. The method may further comprise making the symbol 32 drawn by the user visible on the electronic input device as the symbol is being drawn. The method may further comprise making the symbol drawn by the user reduce in visibility after being drawn, but while the object 34 is still available for use. The method may further comprise providing electrotactility sensation on the electronic input device 14 corresponding to the virtual user input object. The method may further comprise discontinuing the virtual user input object based upon ending of an application or taking a picture or stopping of a recording. The method may further comprise using movement of a finger of the user towards and away from the electronic input device 14 at the drawn symbol 32 as an input component of the virtual user input object. The method may comprise the symbol being drawn by a hand of the user while the hand is in contact with the electronic input device. The method may comprise the symbol being drawn by a hand of the user while the hand is not in contact with the electronic input device.

An example non-transitory program storage device, such as the memory(ies) 24 or a CD-ROM or a flash drive or a network storage for example, readable by a machine, tangibly embodying a program of instructions executable by the machine for performing operations, may comprise the operations of, based upon a user drawing a symbol with an electronic input device, creating a virtual input object for use by the user with the electronic input device corresponding to the drawn symbol; and using user interaction with the virtual input object to perform at least one function.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
an electrical touch surface; and
a controller connected to the touch surface, where based upon a user drawing a symbol on the touch surface the controller is configured to create a virtual user input object at the touch surface corresponding to the drawn symbol.

2. An apparatus as in claim 1 where the controller is configured to create the virtual user input object based upon an application in use by the apparatus when the symbol is drawn.

3. An apparatus as in claim 1 where the controller is configured to use input by the user with the virtual user input object a first way with a first application, and to use the input by the user with the virtual user input object a second different way with a second different application.

4. An apparatus as in claim 1 where the controller is configured to make the symbol drawn by the user visible on the touch surface as the symbol is being drawn.

5. An apparatus as in claim 4 where the controller is configured to make the symbol drawn by the user reduce in visibility after being drawn.

6. An apparatus as in claim 1 where the controller is configured to provide electrotactility sensation on the touch surface corresponding to the virtual user input object.

7. An apparatus as in claim 1 where the controller is configured to discontinue the virtual user input object based upon ending of an application or taking a picture or stopping a recording.

8. An apparatus as in claim 1 where the touch surface and the controller are configured to use movement of a user's finger towards and/or away from the touch surface at the drawn symbol as an input component to the virtual user input object.

9. An apparatus as in claim 1 where the controller is configured to allow the user to move the drawn symbol on the touch surface and move the virtual user input object with the drawn symbol.

10. An apparatus as in claim 9 where the controller is configured to allow the user to change a size of the drawn symbol on the touch surface and change a size of the virtual user input object with the drawn symbol.

11. An apparatus as in claim 1 where the electrical touch surface is a touch screen.

12. An apparatus as in claim 1 comprising means for allowing a user to initiate creation of a semi-custom user input object on the touch screen as the virtual user input object.

13. A method comprising:
drawing a symbol by a user configured to be detected by an electronic input device; and
creating a virtual user input object for use by the user with the electronic input device corresponding to the drawn symbol.

14. A method as in claim 13 where the virtual user input object is created based, at least partially, upon an application in use by an apparatus having the electronic input device when the symbol is drawn.

15. A method as in claim 13 further comprising using input by the user with the virtual user input object a first way with a first application, and using the input by the user with the virtual user input object a second different way with a second different application.

16. A method as in claim 13 further comprising making the symbol drawn by the user visible on the electronic input device as the symbol is being drawn.

17. A method as in claim 13 further comprising making the symbol drawn by the user reduce in visibility after being drawn.

18. A method as in claim 13 further comprising providing electrotactility sensation on the electronic input device corresponding to the virtual user input object.

19. A method as in claim 13 further comprising providing audio output corresponding to the virtual user input object.

20. A method as in claim 13 further comprising discontinuing the virtual user input object based upon ending of an application or taking a picture or stopping of a recording.

21. A method as in claim 13 further comprising using movement of a finger of the user towards and away from the electronic input device at the drawn symbol as an input component of the virtual user input object.

22. A method as in claim 13 where drawing the symbol comprises the symbol being drawn by a hand of the user while the hand is in contact with the electronic input device.

23. A method as in claim 13 where drawing the symbol comprises the symbol being drawn by a hand of the user while the hand is not in contact with the electronic input device.

24. A non-transitory program storage device readable by a machine, tangibly embodying a program of instructions executable by the machine for performing operations, the operations comprising:
based upon a user drawing a symbol with an electronic input device, creating a virtual input object for use by the user with the electronic input device corresponding to the drawn symbol; and
using user interaction with the virtual input object to perform at least one function.
